(19) United States
(12) Patent Application Publication
(10) Pub. No.: US 2018/0263395 A1
(43) Pub. Date: Sep. 20, 2018

(54) BAR MAT HOLDER WITH INSERTABLE CONTAINER HOLDER

(71) Applicant: Anthony Paul Ballew, Seattle, WA (US)

(72) Inventor: Anthony Paul Ballew, Seattle, WA (US)

(21) Appl. No.: 15/922,768

(22) Filed: Mar. 15, 2018

Related U.S. Application Data
(60) Provisional application No. 62/472,382, filed on Mar. 16, 2017.

(51) Int. Cl. A47G 23/03; A47G 19/22; F16C 19/10

(52) U.S. Cl. CPC A47G 23/0316; F16C 19/10; A47G 19/2261

(57) ABSTRACT

An apparatus for securely holding beverage containers comprising a base mat holder having a base, a first vertical sidewall and a second vertical sidewall, the first vertical sidewall and the second vertical sidewall defining a region for placement of a base mat for protection of a base portion of a beverage container, and at least one container-holder for receiving and securely holding the beverage container, the at least one container-holder having a first sidewall and a second sidewall, the first sidewall and the second sidewall being on opposing sides of the at least one container-holder, each sidewall having at least one extension arm extending horizontally from each of the opposing sides of the at least one container-holder, the at least one container-holder slidably inserted onto the base mat holder.

### CROSS-REFERENCE TO RELATED APPLICATION

This application claims the benefit of U.S. Provisional Application No. 62/472,382, entitled “A Bar Mat Holder With A Sliding, Locking Pint Securer and Staging Mat,” filed Mar. 16, 2017.

### FIELD

The present disclosure relates generally to the field of beverage accessories, and in particular but not exclusively, to an apparatus for holding bar beverage mats and glassware for use in bars, restaurants and other entertainment locations where mixed beverages are prepared.

### BACKGROUND

Bars, restaurants and other busy entertainment centers where mixed beverages are prepared often require bartenders or other beverage preparation specialists to make specialty cocktails or other beverages in short periods of time but with exacting standards for quality and consistency. Bartenders in particular must prepare specialty cocktails and beverages with specific limits on the amounts of alcohol or the ingredients based applicable local regulations and the mandates of bar owners and managers. Frequently, the preparation of specialty beverages, especially in exclusive bars and restaurants, is a form of entertainment for guests and occurs as they view the preparation of their orders by bartenders while standing near or seated at bar stools. While engaged in such entertainment preparations, bartenders must nonetheless prepare cocktails or other requested beverages quickly and to exacting standards that limit the contents of these beverages.

One problem encountered by bartenders while preparing such beverages is the breakage of glassware on bar tops. Another problem is the all too frequent spillage of liquids into bar wells or on bar tops. Often, cocktails and other specially-made beverages are prepared on bar mats that are placed on and usual lie flat with bar tops. Such mats are flimsy, poorly-made, poorly-designed, frequently overused and outdated, and ultimately dangerous since the gripping capacity of their rubber surfaces often degrades with continued use and the frequently spillage of liquids containing combinations of alcohol, fruits, liquors, sugars or other specialty ingredients.

Thus, there is a significant need for an apparatus that is sturdy and can hold glassware in stable positions while reducing or eliminating the risk of glassware breakage, eliminating the spillage of liquids during cocktail preparation, and enabling bartenders to move glassware easily, quickly and securely along a bar mat in an enclosed structure from the site of cocktail preparation to each patron while entertaining and delighting them during the preparation of their beverages.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1A is a perspective view of a container-holder in an embodiment.

FIG. 1B is a perspective view of a container-holder in an embodiment.

FIG. 2A is a side view of a container-holder inserted into a base mat holder in an embodiment.

FIG. 2B is a side view of a container-holder inserted into a base mat holder in an embodiment.

FIG. 3A is a side view of a base mat holder in an embodiment.

FIG. 3B is a top view of a base mat holder in an embodiment.

FIG. 4 is a top view of container-holders on a base mat holder in an embodiment.

FIG. 5 is a side view of container-holders on a base mat holder in an embodiment.

### DETAILED DESCRIPTION

In the description to follow, various aspects of embodiments will be described, and specific configurations will be set forth. These embodiments, however, may be practiced with only some or all aspects, and/or without some of these specific details. In other instances, well-known features are omitted or simplified in order not to obscure important aspects of the embodiments.

The description provided herein repeatedly uses the phrases “in one embodiment”, which ordinarily does not refer to the same embodiment, although it may. The terms “comprising”, “including”, “having”, and the like, as used in the present disclosure are synonymous.

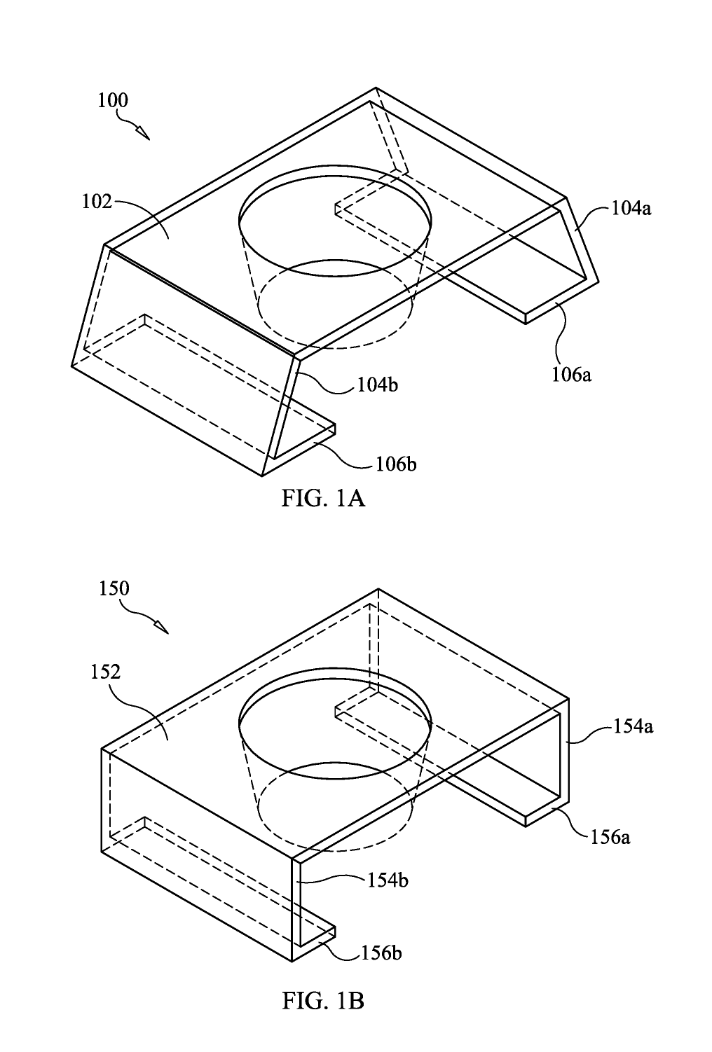

FIG. 1A is an illustration of a container-holder in an embodiment. The container holder 100 has a trapezoidal cross section and is comprised of an upper surface 102, a first side wall 104a, a second side wall 104b, a first extension arm 106a extending from the first side wall 104a, and a second extension arm 106b extending from the second side wall 104b. The container-holder 100 includes a circular space for receiving a beverage container in a central portion of the upper surface 102. The extension arms 106a, 106b are used for insertion of the container-holder 100 into a base mat holder for use in stabilizing the position of beverage containers (e.g., glassware, mixing cups, etc.). The material composition of the container-holder 100 is hard plastic in a first embodiment. In an alternative embodiment, the container-holder 100 is comprised of graphene. Graphene in particular offers significant advantageous for use in a container-holder since it is a material with strength and durability. In a preferred embodiment, the thickness of the upper surface 102, the first side wall 104a and the second side wall 104b is from five (5) to eight (8) centimeters. The thickness of each extension arm 106a, 106b can vary depending on the gap spacing defined between the extension arms of a base mat holder. In an embodiment, the height of the container-holder 100 is 15-20 centimeters and its width from the widest point at the intersections formed by the first side wall 104a and the first extension arm 106a and the second side wall 104b and the second extension arm 106b is 8-15 centimeters. In alternative embodiments, two or more extensions arms are provided on each side wall where insertion into a base mat holder having two or more insertion slots is provided.

FIG. 1B illustrates an alternative embodiment of a container-holder 150 with a rectangular cross section. The container holder 150 is comprised of an upper surface 102, a first side wall 154a, a second side wall 154b, a first extension arm 156a extending from the first side wall 154a, and a second extension arm 156b extending from the second side wall 154b. The container-holder 150 includes a circular space for receiving a beverage container in a central portion of the upper surface 152. The extension arms 156a, 156b are used for insertion of the container-holder 150 into a base mat holder that is used to stabilize the position of beverage containers (e.g., glassware, mixing cups, etc.). The material composition of the container-holder 150 is hard plastic in a first embodiment. In an alternative embodiment, the container-holder 150 is comprised of graphene. Graphene offers significant advantageous for use in a container-holder since it is a material with sufficient strength and durability for the intended use of both a base mat holder and the container-holder 150 (i.e., bars, etc.). In the illustrated embodiment, the height of the container-holder 150 is 15-20 centimeters and its width from the outer edge of the first side wall 154a to the outer edge of the second side wall 154b is 50-60 centimeters. In a preferred embodiment, the thickness of the upper surface 152, the first side wall 154a and the second side wall 154b is from five (5) to eight (8) centimeters while the thickness of each extension arm 156a, 156b can vary depending on the gap spacing defined between the extension arms of a base mat holder. In still other alternative embodiments, two or more extensions arms are provided on each side wall where insertion into a base mat holder having two or more insertion slots is provided.

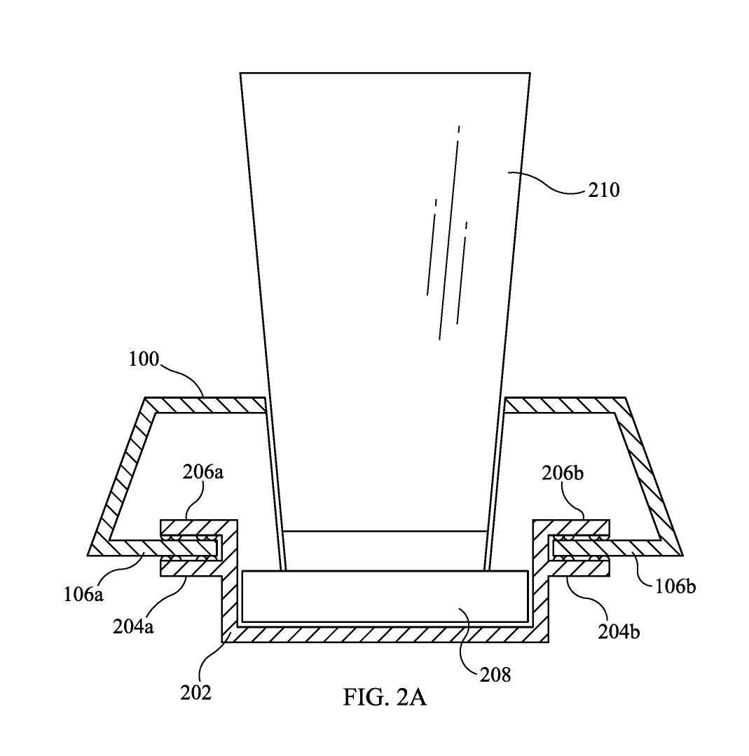

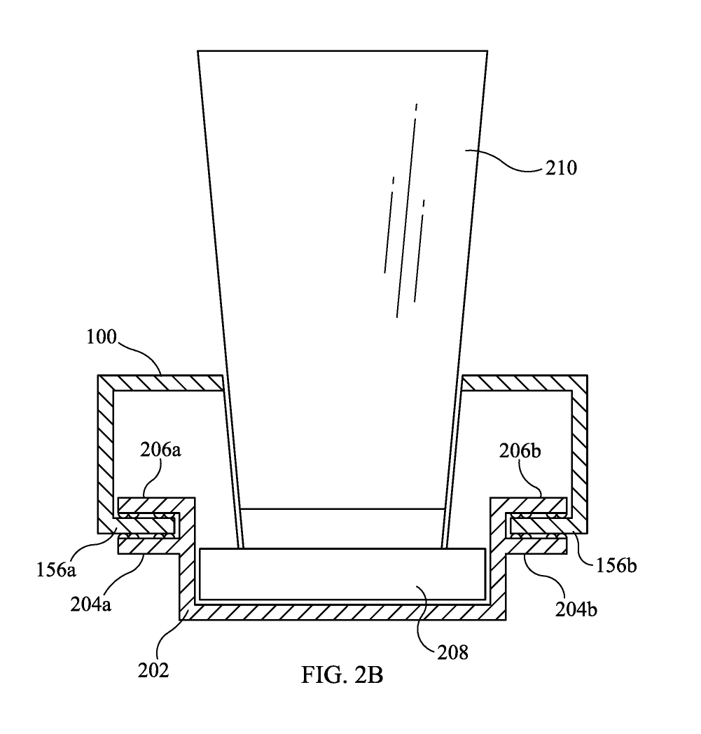

FIG. 2A is a cross-sectional view of the container holder 100 depicted in FIG. 1A in an embodiment illustrating its use in receiving and securely holding a beverage container 210. In this illustrated embodiment, the container-holder 100 is shown having a width and material thickness sufficient to receive and securely hold a beverage container 210 within a space on its upper surface 102. The cross-sectional shape of the container-holder 100 in this embodiment has the trapezoidal shape (as illustrated in FIG. 1). A first extension arm 106a and a second extension arm 106b of the container-holder 100 are shown inserted into a gap formed by upper and lower extension arms on a base mat holder 202. On the left side of the base mat holder 202, the upper extension arm 206a and the lower extension arm 204a are shown with the extension arm 106a of the container holder 100 inserted within the gap. The lower surface of the upper extension arm 206a and the upper surface of the lower extension arm 204a each have two or more rows of ball bearings placed within their contact surfaces. Although the ball bearings in this illustrated embodiment are contact-type ball bearings, in alternative embodiments the extension arms of the container-holder 100 can be received within a space or gap defined by extension arms 206a, 204a, 206b and 204b without ball bearings with use of alternative plastic materials that permit ease of sliding entry into this gap. In yet a different embodiment, the container-holder 100 is connected to the extension arms 206a, 204a, 206b and 204b by a clasp or other similar mechanical securing mechanisms.

The base mat holder 202 forms a region in which a mat 208 is placed on which a beverage container 210 is located after insertion through the upper surface 102 of the container-holder 100. Similar to the structure on the left side, the right side of the base mat holder 202 is comprised of an upper extension arm 206b and a lower extension arm 204b. Together the extension arms 206b, 204b define a gap for receiving the extension arm 106B.

In this embodiment, the upper extension arm 206b includes a region for receiving two or more rows of ball bearings and the lower extension arm 204b also includes a region for receiving ball bearings. The ball bearings used in the illustrated embodiment are contact-type ball bearings and are used to enable sliding connectivity with the extension arm 106b as is the case with the slidable connection formed between the upper and lower extension arms 206a and 204a defining the space in which the extension arm 106a is inserted on the left side of the container-holder 100.

FIG. 2B is a cross-sectional view of the container holder 150 depicted in FIG. 1B with its rectangular profile shown here receiving and securely holding a beverage container 210 on a base mat 208 placed within a region defined by the base mat holder 202. The base mat holder 202 includes on its left side an upper extension arm 206a and a lower extension arm 204a which together define a gap of between five (5) to ten (10) centimeters in length for receiving the left-most extension arm 156a of the container-holder 150. The right side of the base mat holder 202 includes an upper extension arm 206b and a lower extension arm 204b which together also define a gap of between five (5) to ten (10) centimeters in length for receiving the extension arm 156b on the right side of the container-holder 150. The container-holder 150 in this embodiment is slidably connected to the base mat holder 202 using two or more rows of ball bearings placed on the inner surfaces defining the gap between the extension arms 206a, 204a, 206b, 204b of the base mat holder 202. The inner surfaces of the upper extension arm 206a and the upper extension arm 206b each include a region for receiving and mounting contact-type ball bearings. The upper surface of the lower extension arms 204a and 204b also include regions for receiving and securely mounting contact-type ball bearings so that collectively both the upper and lower rows of ball bearings enable a slidable connection for the extension arms 156a, 156b of the container-holder 150.

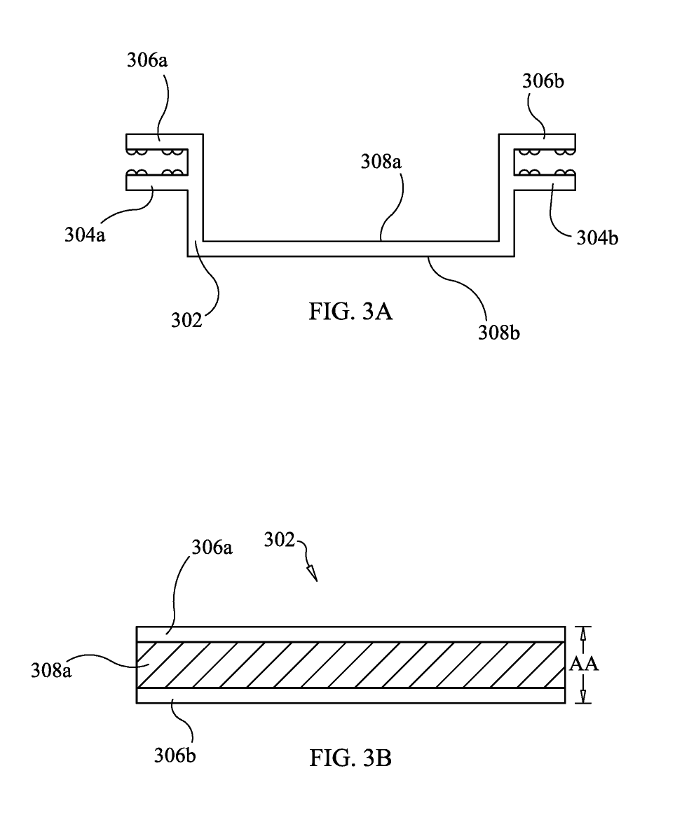

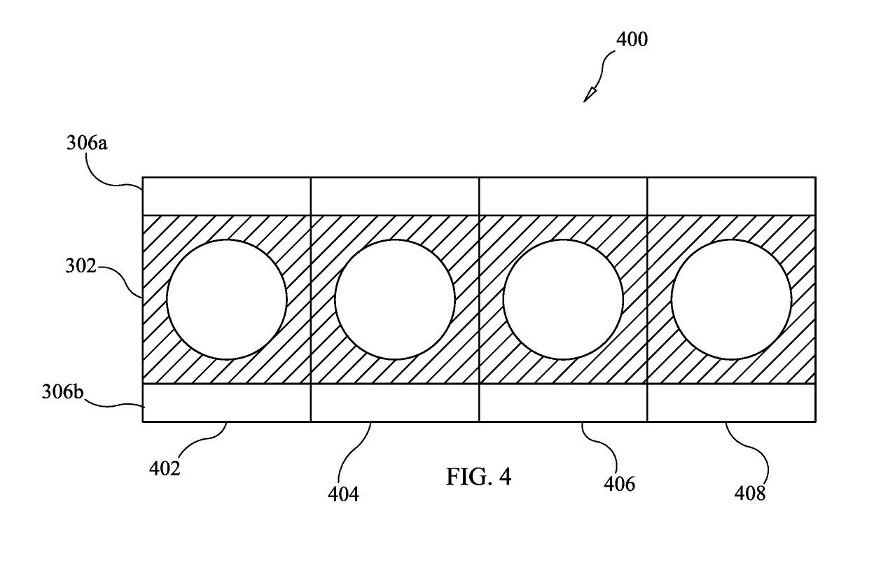

In FIG. 3A an embodiment of a base mat holder 302 is depicted. In this embodiment, the base mat holder 302 includes an inner surface 308a, a lower outer surface 308b and two pairs of extension arms, one pair extending from each of two vertical sidewalls. The inner central region defined by the shape of the base mat holder 302 is used for the receipt and placement of a base mat that serves to stabilize and contain spillage from a beverage container placed on the base mat holder 302. The material composition of the base mat holder 302 in one embodiment is stainless steel while in an alternative embodiment is graphene. Both materials are sturdy, durable and can be exposed to the variety of liquids used in contemporary beverages (e.g., alcoholic mixed drinks, cocktails, juices, etc.) The thickness of the base mat holder 302 and each of the extension arms 306a, 306b, 304a, 304b is from nine (9) to twelve (12) centimeters. The left side of the base mat holder 302 includes an upper extension arm 306a and a lower extension arm 304b which are separated by a gap that is sized to receive and slidably retain an extension arm from a container-holder. The lower surface of the upper extension arm 306a includes one or more rows of contact-type ball bearings. Similarly, the upper surface of the lower extension arm 304a includes a region for receiving and securely mounting one or more rows of contact-type ball bearings. In a preferred embodiment the diameter of each ball bearing used in upper extension arm 306a and the lower extension arm 304a is from one (1) to five (5) centimeters.

Although the illustrated embodiment depicts two distinct sections separated by a small distance comprised of two rows of ball bearings, in alternative embodiments there may be multiple rows of contact-type ball bearings without a gap or space in between pairs of rows of the ball bearings. The horizontal length of each row of ball bearings in the illustrated embodiment is at least 240 to 260 centimeters although in alternative embodiments this distance can vary depending on the inclusion of two or more distances between sections of ball bearing rows. In a further alternative embodiment, the inner surfaces defining the gap into which the extension arms of container-holders are inserted include no ball bearings but instead are comprised of material suitable for secure and slidable connection of container-holders onto and off of the base mat holder 302.

FIG. 3B is a top view of a bar mat holder 302 in an embodiment. The illustrated embodiment is rectangular in shape and is comprised of two parallel extension arms 306a, 306b atop two vertical side walls which structurally define a region for receipt of a base mat (region 308a). Although the illustrated embodiment of the bar mat holder 302 is rectangular in shape, in a different embodiment the base mat holder 302 can be square or, alternatively, two or more bar mat holders 302 are combined to extend the length of a region used for holding a base mat. In a preferred embodiment, the outer side-to-side width of the base mat holder 302 is from approximately 47 to 55 centimeters and is marked in this figure by the symbols “AA.” The inner width between each vertical sidewall of the base mat holder 302 is from approximately 35 to 42 centimeters.

FIG. 4 illustrates an embodiment of a base mat holder 302 on which four different container-holders have been placed by slidably inserting them onto the base mat holder 302. In this embodiment, the container-holders 402,404,406,408 are shown proximate to each other and aligned on the base mat holder 302. The extension arms of each container holder 306a, 306b have been slidably inserted into a gap defined by an upper extension arm and a lower extension arm on each side of the base mat holder 302. In this top view, the extended side walls of the trapezoidal variant of the container-holder (shown in FIG. 1A) is shown deployed on the base mat holder 302. Each of the container-holders 402,404,406,408 includes a circular space on its upper surface for receiving and securely holding beverage containers to enable the efficient preparation of beverages (e.g., mixed alcoholic drinks) with possible multiple mixed elements while inserted and stabilized on the base mat holder 302.

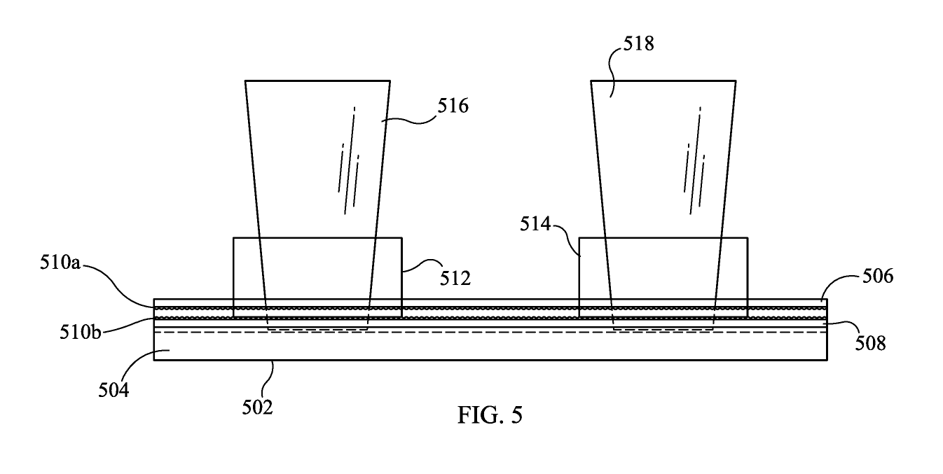

FIG. 5 is a side view of a base mat holder 502 on which two container-holders 512, 514 have been slidably placed. The first container-holder 512 has received and is securely holding a beverage container 516 while the second container-holder 514 has also received and securely holds a different beverage container 518. The upper extension arm on the side of the base mat holder 502 in this figure is shown here as extension arm 506 while the lower extension arm 508 is near the mid-point of the vertical height of the vertical sidewall. In this embodiment, the inner surfaces of the extension arm 506 and extension arm 508 each include and have deployed within them one or more rows of ball bearings 510a, 510b to enable each container-holder to be slidably connected into the base mat holder 502. The base of the base mat holder 502 includes a base mat 504 which in a preferred embodiment is a bar mat for use in receiving and stabilizing the positions of beverage containers used for the mixing of various mixed drinks.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What I claim is:

1. An apparatus for securely holding beverage containers, the apparatus comprising:
a base mat holder, the holder having a base, a first vertical sidewall and a second vertical sidewall, the first vertical sidewall and the second vertical sidewall defining a region for placement of a base mat for protection of a base portion of a beverage container; and
at least one container-holder for receiving and securely holding the beverage container, the at least one container-holder having a first sidewall and a second sidewall, the first sidewall and the second sidewall being on opposing sides of the at least one container-holder, each sidewall having at least one extension arm extending horizontally from each of the opposing sides of the at least one container-holder, the at least one container-holder slidably inserted onto the base mat holder.

2. The apparatus of claim 1 wherein the base mat holder further includes a first plurality of extension arms and a second plurality of extension arms, the first plurality of extension arms horizontally extending from the first vertical sidewall, the second plurality of extension arms horizontally extending from the second vertical sidewall, each of the plurality of extension arms defining a gap for receiving the at least one extension arm on each opposing side of the at least one container-holder.

3. The apparatus of claim 2 wherein a surface on each of the plurality of extension arms defining the gap includes a plurality of rows of ball bearings mounted therein.

4. The apparatus of claim 3 wherein the at least one container-holder is slidably connected to the base mat holder when each of the at least one extension arm is slidably coupled to the plurality of ball bearings.

5. The apparatus of claim 1 wherein the at least one container-holder is comprised of at least one of a plastic material and a carbon material.

6. The apparatus of claim 5 wherein the carbon material is graphene.

7. The apparatus of claim 3 wherein the diameter of each ball bearing is from approximately one (1) centimeter to five (5) centimeters.

8. The apparatus of claim 3 wherein the horizontal length of each of the plurality of rows of ball bearings is at least 240 centimeters.

9. The apparatus of claim 3 wherein each of the plurality of rows of ball bearings mounted in each of the plurality of extension arms are contact-type bearings.

10. The apparatus of claim 1 wherein the extension arms on each of the first plurality of extension arms and the second plurality of extension arms form the gap of approximately five (5) to ten (10) centimeters in length.

11. The apparatus of claim 1 wherein the at least one container-holder further includes an upper surface connected each of the first sidewall and the second sidewall, the upper surface having a space for receiving and securely holding the beverage container, a height from an upper surface of the base mat to an outer face of the upper surface marking a volumetric location on the beverage container equal to three (3) ounces of a poured beverage.

12. The apparatus of claim 11 wherein a thickness of the upper surface, the first sidewall and the second sidewall is at least five (5) centimeters.

13. The apparatus of claim 1 wherein a thickness of the base, the first vertical sidewall and the second sidewall is at least nine (9) centimeters.

14. The apparatus of claim 1 wherein the base mat holder is comprised of stainless steel and the base mat is a bar mat.

15. A method for securely holding beverage containers, the method comprising:
providing a base mat holder having a region for placement of a base portion of a beverage container;
sliding at least one container holder along a length of the provided base mat holder;
providing a beverage container within each of the at least one container holder; and
securing the beverage container within the at least one container holder in a position along the length of the provided base mat holder, the secured beverage container position identifying a volumetric location equal to three (3) ounces of a poured beverage.

16. The method of claim 15 wherein the sliding of the at least one container holder comprises sliding a first extension arm and a second extension arm of the holder between a plurality of ball bearings, the ball bearings being disposed within a first inner surface and a second inner surface of a plurality of extension arms on opposing sides of the at least one container holder.
